(19) United States
(12) Patent Application Publication
(10) Pub. No.: US 2026/0177669 A1
(43) Pub. Date: Jun. 25, 2026

(54) DISTANCE MEASURING APPARATUS

(71) Applicant: Stanley Electric Co., Ltd., Tokyo (JP)

(72) Inventor: Atsuhiko CHIKAOKA, Tokyo (JP)

(73) Assignee: Stanley Electric Co., Ltd., Tokyo (JP)

(21) Appl. No.: 19/394,956

(22) Filed: Nov. 20, 2025

(30) Foreign Application Priority Data
Dec. 19, 2024 (JP) 2024-224293

(51) Int. Cl. G01S 7/481; G01S 17/10

(52) U.S. Cl. CPC G01S 7/4815; G01S 7/4817; G01S 17/10

(57) ABSTRACT

A distance measuring apparatus where a unit frame in which a controller measures the distance is divided into multiple sub-frames, and a measurement direction group assigned to each sub-frame is set to be mutually exclusive, where, when multiple reflection points are detected in a first sub-frame, which is earlier in time than other sub-frames, based on a light flight time at each reflection point, the controller sets a first area including each reflection point; and where, in a second sub-frame, which is one of the multiple sub-frames later in time than the first sub-frame, the controller controls the operation of the light source and the deflector so that a measurement light is not irradiated from the measurement direction group included in the second sub-frame to a measurement direction overlapping the first area, and the measurement light is irradiated to the measurement direction that does not overlap with the first area.

### CROSS-REFERENCE TO RELATED APPLICATION

The present application is based on, and claims priority from, JP Application Serial Number, 2024-224293 filed on Dec. 19, 2024, the disclosure of which is hereby incorporated by reference herein in its entirety.

### BACKGROUND

### Technical Field

The present disclosure relates to a distance measuring apparatus.

### Description of the Background Art

A device that detect an object by irradiating laser light and detecting the resulting reflected light are publicly known. For example, Japanese Laid-Open Patent Publication No. 2022-112828 describes a distance image photographing device that includes: a photoelectric conversion element that generates charge in response to incident light; a plurality of pixel circuits having N (N≥3) charge storage units that accumulate charge per frame cycle; a light receiving unit having a pixel drive circuit that distributes and accumulates charges by turning on and off transfer transistors that transfer charges to the charge storage units at storage timing synchronized with a pulsed light; a light source unit that irradiates the pulsed light; a distance image processing unit that calculates the distance to a subject based on the amount of accumulated charges in the charge storage units; and a measurement control unit that accumulates charges in one of measurement zones set to zone threshold values corresponding to the distance, with an accumulation count set for the measurement zone to which the measured distance belongs, and increases the pulse cycle of the pulsed light as the accumulation count increases.

The above-described distance image photographing device appears to have the advantage of meeting human safety standards (eye safety) even when the pulsed light is continuously emitted.

However, when the subject is far away, the number of accumulation count increases and the pulse cycle, which is the interval between the emission of the pulsed light, becomes longer, which means that the measurement time increases, and there is thought to be room for improvement.

In a specific aspect, it is an object of the present disclosure to provide, in a distance measuring apparatus using laser light, a technology that can suppress an increase in measurement time and ensure detection performance for a distant object.

### SUMMARY

A distance measuring apparatus according to one aspect of the present disclosure is an apparatus for measuring a distance to an object, including:
a light source that emits a laser light;
a deflector that generates a measurement light by deflecting the laser light;
a sensor that receives a reflected light which is generated when the measurement light is irradiated on the object;
a controller configured to control the operation of the light source and the deflector, and configured to measure the distance to the object based on the reflected light received by the sensor;
wherein a unit frame in which the controller measures the distance is divided into a plurality of sub-frames, and a measurement direction group assigned to each of the plurality of sub-frames is set to a mutually exclusive arrangement;
wherein, when a plurality of reflection points is detected in a first sub-frame, which is relatively earlier in time among the plurality of sub-frames, based on a light flight time at each of the plurality of reflection points or a converted value equivalent to the light flight time, the controller sets a first area that includes each of the plurality of reflection points; and
wherein, in a second sub-frame, which is at least one of the plurality of sub-frames which is relatively later in time than the first sub-frame, the controller controls the operation of the light source and the deflector so that the measurement light is not irradiated from the measurement direction group included in the second sub-frame to one or more measurement directions that overlap with the first area, and the measurement light is irradiated to the measurement direction that does not overlap with the first area.

According to the above configuration, in a distance measuring apparatus using laser light, it is possible to provide a technology that suppresses an increase in measurement time and ensure detection performance for a distant object.

### BRIEF DESCRIPTION OF THE DRAWINGS

FIG. 1 is a diagram showing the configuration of a distance measuring apparatus according to one embodiment.

FIG. 2 is a diagram illustrating an example of the arrangement of the light source and the light receiving unit, and a light receiving visual field.

FIG. 3 is a diagram illustrating a measurement direction group determined by the emission of measurement light.

FIG. 4 is a diagram schematically showing objects within the scanning target area FOI.

FIG. 5 is a diagram illustrating the assignment of sub-direction groups.

FIG. 6A is a diagram illustrating the measurement directions and reflection points in sub-frame 0.

FIG. 6B is a diagram illustrating the measurement directions and reflection points in sub-frame 1.

FIG. 7A is a diagram illustrating the measurement directions and reflection points in sub-frame 2.

FIG. 7B is a diagram illustrating the measurement directions and reflection points in sub-frame 3.

FIG. 8 is a diagram illustrating the measurement directions and reflection points for a unit frame, which combines sub-frames 0 to 3.

FIG. 9 is a flowchart showing the information processing flow for measuring one frame of the distance measuring apparatus of the present embodiment.

FIG. 10A and FIG. 10B are diagrams each illustrating the method for setting area B, which is subject to thinning processing of the measurement direction(s).

FIG. 11A, and FIG. 11B are diagrams each illustrating the method for setting area B, which is subject to thinning processing of the measurement direction(s).

FIG. 12A is a diagram showing area B_{OA,SF0}, which is the union of areas B_{OA,SF0,m}, B_{OA,SF0,n}, B_{OA,SF0,o}, and B_{OA,SF0,p}.

FIG. 12B is a diagram illustrating the method for setting area B, which is subject to thinning processing of the measurement direction.

FIG. 13 is a diagram showing an example of a pattern of area B which is set in advance.

FIG. 14A is a diagram for explaining an example of a case where the number of sub-direction groups subject to thinning processing is set to a small number.

FIG. 14B is a diagram illustrating an example when switching the assigned pattern to each frame sequentially from P1 to P4.

FIG. 15 is a flowchart showing the information processing flow for measuring one frame in the distance measuring apparatus of modified example 1.

FIG. 16A is a diagram for explaining an example of a method for dividing a scanning target area FOI into a plurality of areas.

FIG. 16B is a diagram illustrating the enlarged central area.

FIG. 17 is a diagram for explaining a method of changing thinning processing parameters for each part of the scanning target area FOI.

FIG. 18 is a diagram showing an example of a modified configuration of the light source unit.

### DESCRIPTION OF THE PREFERRED EMBODIMENTS

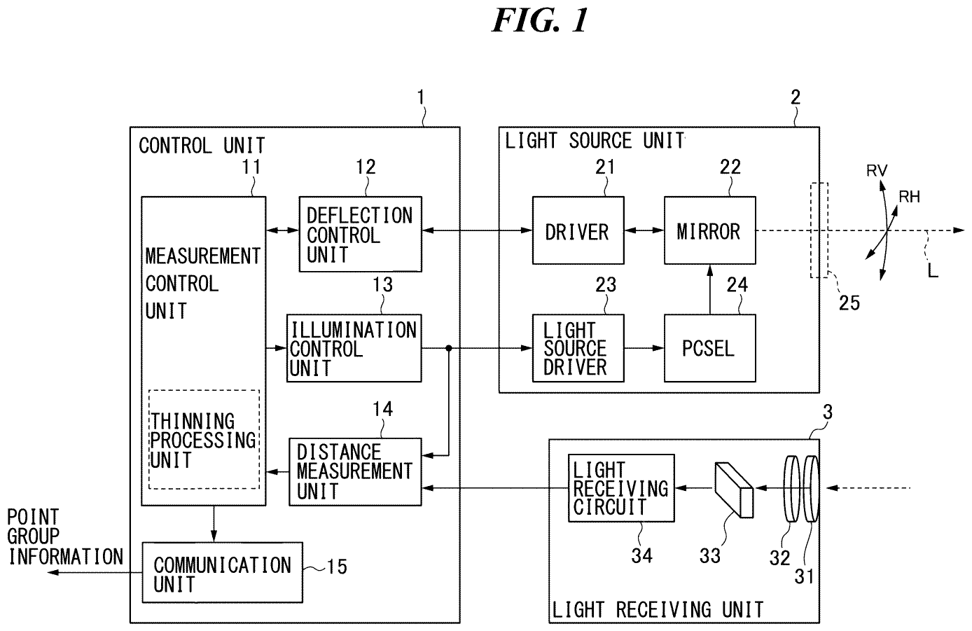

FIG. 1 is a diagram showing the configuration of a distance measuring apparatus according to one embodiment. The distance measuring apparatus (object detection apparatus) of the present embodiment performs optical scanning on a target space using measurement light (emission light) which is laser light, and receives reflected light which is generated when the measurement light strikes an object, detects the position and relative distance of the object present in the target space by using time required for the reflected light to be obtained (light flight time). The apparatus is configured to include a control unit (controller) 1, a light source unit 2, and a light receiving unit 3. In other words, the distance measuring apparatus of the present embodiment operates using time-of-flight method.

Control unit 1 controls the overall operation of the distance measuring apparatus and can be realized by using a computer system equipped with a CPU, ROM, RAM, etc. and having the computer system execute a predetermined operating program, for example. Within control unit 1, to clearly illustrate each function realized by executing the operation program, control unit 1 is configured to include a measurement control unit (measurement control function) 11, a deflection control unit (deflection control function) 12, an illumination control unit (illumination control function) 13, a distance measurement unit (distance measurement function) 14, and a communication unit (communication function) 15.

Measurement control unit 11 controls the operation of deflection control unit 12, illumination control unit 13, and distance measurement unit 14. Further, measurement control unit 11 has a thinning processing unit (thinning processing function) for thinning out the emission direction (measurement direction) of the measurement light.

Deflection control unit 12 controls a mirror 22 via a driver 21 of light source unit 2 so that the mirror periodically deflects in a specified angle change pattern (typically a raster scan with evenly spaced scan lines).

Illumination control unit 13 controls a PCSEL 24 via a light source driver 23 so that PCSEL 24 emits laser light under the pulse conditions specified by measurement control unit 11.

Distance measurement unit 14 measures the distance between an object in the target space based on the time difference between the emission time and the reception time of the measurement light, using the measurement light generation command timing of the measurement light by illumination control unit 13 and the light reception signal obtained from a light receiving circuit 34 of light receiving unit 3. Further, based on the emission time and the reception time of the measurement light, measurement control unit 11 detects three-dimensional position of the object.

Communication unit 15 receives point group information (a collection of three-dimensional positions) obtained by distance measurement unit 14 from measurement control unit 11, and transmits this point group information to an external device (not shown).

Light source unit 2 generates measurement light which is a narrow-angle beam of laser light, and emits the light in various directions within a predetermined range. Light source unit 2 is configured to include a driver 21, a mirror 22, a light source driver 23, and a PCSEL 24.

Driver 21 is connected to both control unit 1 and mirror 22. Under the control of deflection control unit 12 of control unit 1, driver 21 generates a drive signal that controls the operation of mirror 22 and supplies it to mirror 22.

Mirror 22 has a reflective surface and is rotatable about two orthogonal axes. Mirror 22 is a two-dimensional deflector that deflects laser light emitted from PCSEL (Photonic-Crystal Surface-Emitting Laser) 24. Mirror 22 rotates about a primary axis (first axis) and a secondary axis (second axis) which is orthogonal to the primary axis, and is configured using a MEMS mirror, for example. This mirror 22 rotates based on a drive signal supplied from driver 21, thereby scanning the laser light in two directions within the target space. The measurement light generated by scanning via mirror 22 is emitted to external space (scanning target area) through an opening 25 appropriately provided at light source unit 2. In the figure, RH indicates the deflection direction due to rotation of mirror 22 about the primary axis, and RV indicates the deflection direction due to rotation of mirror 22 about the secondary axis.

Light source driver 23 is connected to both control unit 1 and PCSEL 24. Under the control of illumination control unit 13 of control unit 1, light source driver 23 generates a drive signal that controls the operation of PCSEL 24 and supplies the signal to PCSEL 24.

PCSEL 24 is a near-infrared photonic crystal surface-emitting laser that emits a laser light with a small divergence angle toward mirror 22. The laser light emitted from PCSEL 24 has a divergence angle comparable to (the same as or less than) the angular resolution of the distance measuring apparatus. Here, note that while PCSEL 24 is an example of a light source, the light source that can be used in the present disclosure is not limited thereto, and various laser light sources can be used, preferably those capable of emitting laser light with a narrow angle beam. The laser light emitted from PCSEL 24 can be a pulsed light with a wavelength of 940 nm and a divergence angle of 0.1°, for example. In other words, it is sufficient that the light emitted from light source unit 2 has a divergence angle comparable to (the same as or less than) the angular resolution of the distance measuring apparatus. Further, light source unit 2 may also be provided with an optical system that shapes the beam profile of the emitted light as appropriate.

Light receiving unit 3 receives reflected light generated when measurement light is irradiated onto an object, and the unit generates a light receiving signal. Light receiving unit 3 is configured to include a lens 31, an optical filter 32, a sensor 33, and a light receiving circuit 34.

Lens 31 collects the reflected light generated when the measurement light from PCSEL 24 is irradiated onto the object.

Optical filter 32 is positioned downstream of lens 31 and blocks light of a wavelength range different from that of the measurement light, while transmitting light of the same wavelength range as that of the measurement light.

Sensor 33 detects light incident through optical filter 32. In the present embodiment, sensor 33 has multiple light-receiving elements arranged in two directions.

Light receiving circuit 34 generates a light receiving signal by performing predetermined signal processing (e.g., amplification, frequency filtering, current-to-voltage conversion, etc.) on the output of sensor 33. The generated light receiving signal is supplied to distance measurement unit 14 of control unit 1.

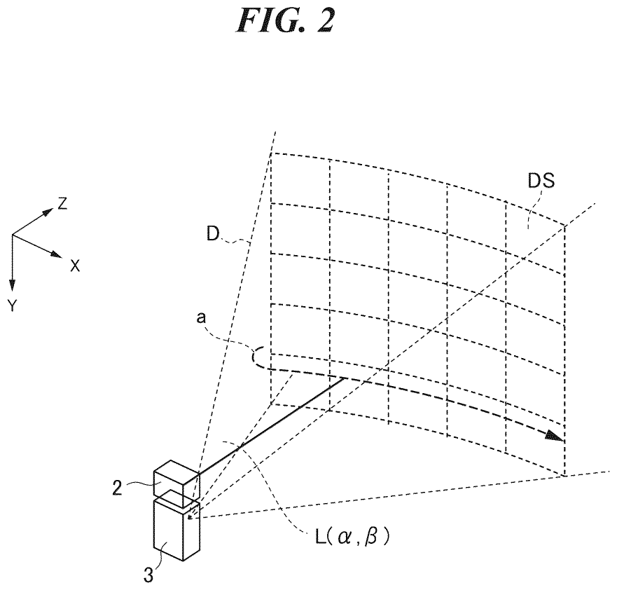

FIG. 2 is a diagram illustrating an example of the arrangement of the light source and the light receiving unit, and a light receiving visual field. In the illustrated example, a light source 2 and a light receiving unit 3 are arranged along the Y direction (vertical direction). The measurement light L (α, β) emitted from light source 2 is scanned two-dimensionally along the X direction and the Y direction (refer to the scanning trajectory “a”). In this example, the scanning direction along the X direction is defined as the main scanning direction. The entire area scanned by the measurement light L (α, β) corresponds to a light receiving visual field D of sensor 33. The light receiving visual field D is divided into regions at predetermined intervals along the X direction and the Y direction, and each region is referred to as a partial light receiving visual field DS. This partial light receiving visual field DS may correspond to each one of the multiple light receiving elements included in sensor 33, or to a group of several adjacent light receiving elements. Here, note that α and β are variables representing the rotation angle of MEMS mirror 22, with a corresponding to the primary axis rotation angle θ_{H}, and β corresponding to the secondary axis rotation angle θ_{V}. The measurement light L(α, β) indicates the measurement light when the primary axis rotation angle θ_{H}=α and the secondary axis rotation angle θ_{V}=β.

Deflection control unit 12 of control unit 1 controls driver 21 of light source unit 2 based on preset primary axis rotation angle θ_{H} and secondary axis rotation angle θ_{V}, thereby controlling the deflection angle of mirror 22. As a result, measurement light is emitted in a direction determined based on preset primary axis rotation angle θ_{H} and secondary axis rotation angle θ_{V}. Then, the reflected light generated by the measurement light is received by light receiving unit 3, and by processing a group of received light signals, for each partial light receiving visual field DS, the distance to the reflected object is obtained.

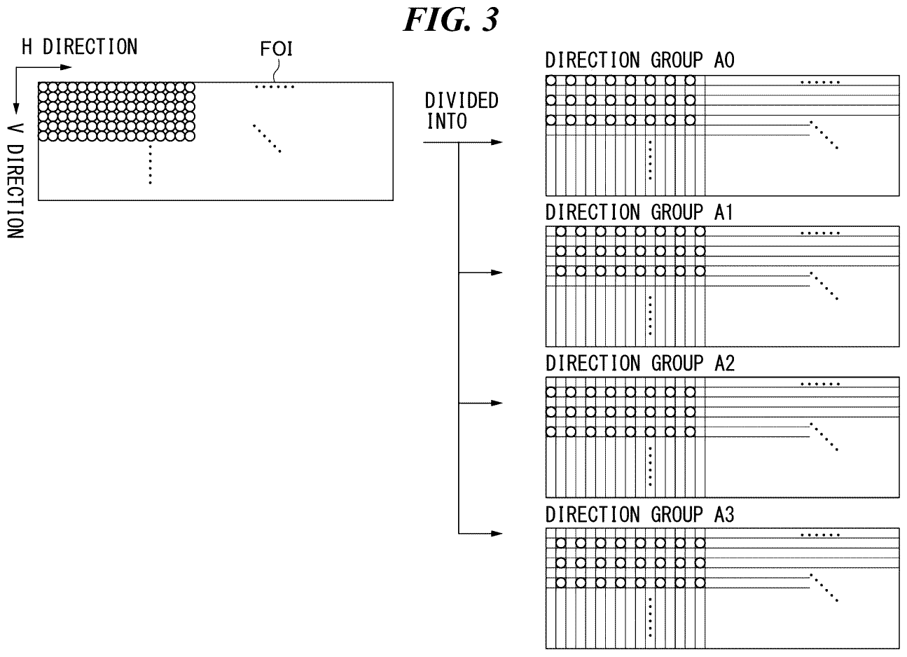

FIG. 3 is a diagram illustrating a measurement direction group determined by the emission of measurement light. Measurement control unit 11 controls deflection control unit 12 and illumination control unit 13 to control the direction in which each measurement light is emitted (hereinafter referred to as “measurement direction”). Specifically, the measurement direction is set for each substantially fixed angle that is set based on the angular resolution so as to cover a scanning target area FOI. Here, the scanning target area FOI is the area in which the measurement lights are irradiated. Further, a measurement direction group can also be described as a set of deflection angles corresponding to the positions where the measurement lights are irradiated. As an example, measurement directions are set in 0.1° increments in both the H direction and the V direction. In the diagram, each measurement direction is indicated by a circle. Further, as an example, the scanning target area FOI can be set to a range of 90° in the H direction and 120 in the V direction. Here, it should be noted that the measurement directions do not necessarily have to be uniformly distributed throughout the entire scanning target area FOI, but for ease of understanding, an example in which measurement directions are uniformly distributed will be used here.

The measurement direction group can be divided into four sub-direction groups A0, A1, A2, and A3, as shown in the diagram. That is, a minimum unit frame used to acquire data for the measurement direction group which covers scanning target area FOI can be divided into sub-frames corresponding to each sub-direction group for measurement. The measurement direction groups included in each of the sub-direction groups A0, A1, A2, and A3 are mutually exclusive. That is, the measurement direction group included in sub-direction group A0 is not included in other sub-direction groups A1, A2, and A3. Similarly, the measurement direction group included in sub-direction group A1 is not included in other sub-direction groups A0, A2, and A3. Similarly, the measurement direction group included in sub-direction group A2 is not included in other sub-direction groups A0, A1, and A3. Similarly, the measurement direction group included in sub-direction group A3 is not included in other sub-direction groups A0, A1, and A2.

In the illustrated example, the measurement directions in each of the sub-direction groups A0 to A3 are arranged intermittently, leaving one open, in the H direction and the V direction. In sub-direction group A1, using sub-direction group A0 as the reference, the measurement directions are arranged shifted by one position in the H direction. In sub-direction group A2, using sub-direction group A0 as the reference, the measurement directions are arranged shifted by one position in the V direction. In sub-direction group A3, using sub-direction group A0 as the reference, the measurement directions are arranged shifted by one position in both the H direction and the V direction. It can also be said that, in sub-direction group A3, using sub-direction group A1 as the reference, the measurement directions are arranged shifted by one position in the V direction, and it can also be said that, in sub-direction group A3, using sub-direction group A2 as the reference, the measurement directions are arranged shifted by one position in the H direction.

The density of the measurement directions (i.e., the number of measurement directions) included in each of the sub-direction groups A0 to A3 is approximately the same. Here, “approximately the same” means that there can be an error of several (e.g., 5 to 10) in the number of measurement directions included in each of the sub-direction groups A0 to A3. Note that the divided number of sub-direction groups is not limited to four. Further, each measurement direction included in each of the sub-direction groups need only be arranged mutually exclusive, and are not limited to the arrangement shown in the example.

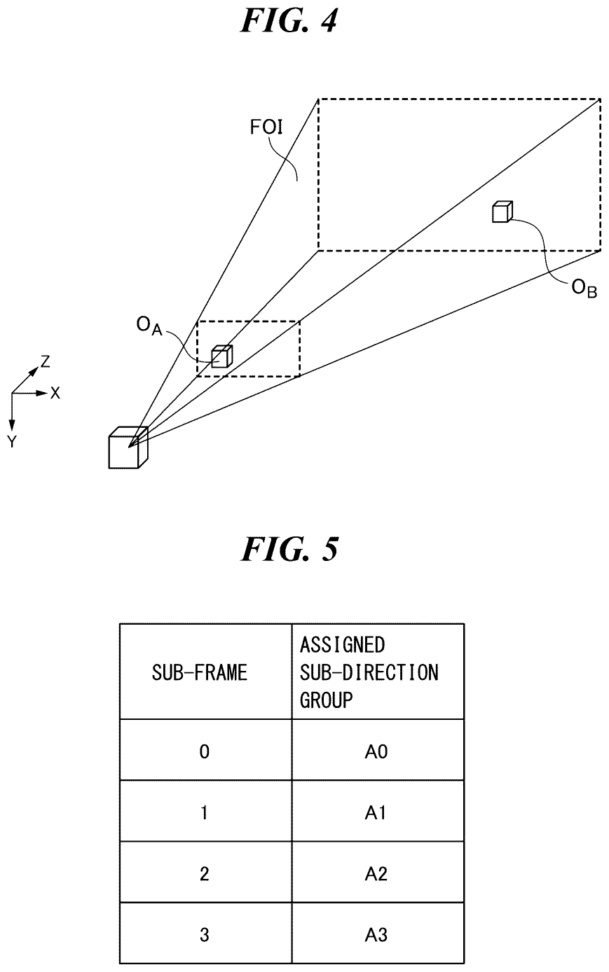

FIG. 4 is a diagram schematically showing objects within the scanning target area FOI. Here, an object located relatively close to the distance measuring apparatus is referred to as O_{A}, and an object located relatively far away is referred to as O_{B}. In the present embodiment, a unit frame, which is the smallest unit for three-dimensional measurement, is divided into four sub-frames, and measurement is performed by assigning one of the sub-direction groups A0 to A3 described above to each sub-frame (refer to FIG. 5). In this case, reflection points respectively corresponding to objects O_{A} and O_{B} are detected in sub-frame 0 (zero), which is the first sub-frame (i.e., sub-frame which is relatively earlier in terms of timing). Accordingly, in subsequent sub-frames, specifically sub-frames 1 through 3, which are relatively later in terms of timing, the measurement light directed toward the direction which includes the reflection point corresponding to the relatively close object O_{A} is omitted. In the following, assuming the arrangement of each object as illustrated in FIG. 4, this process will be described in detail.

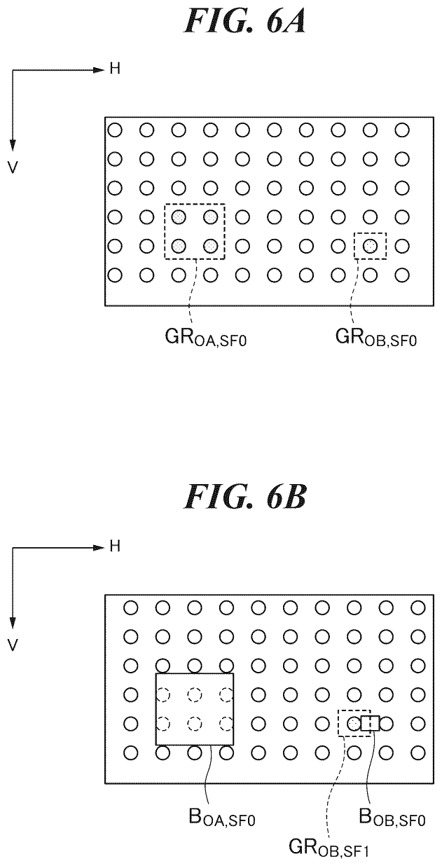

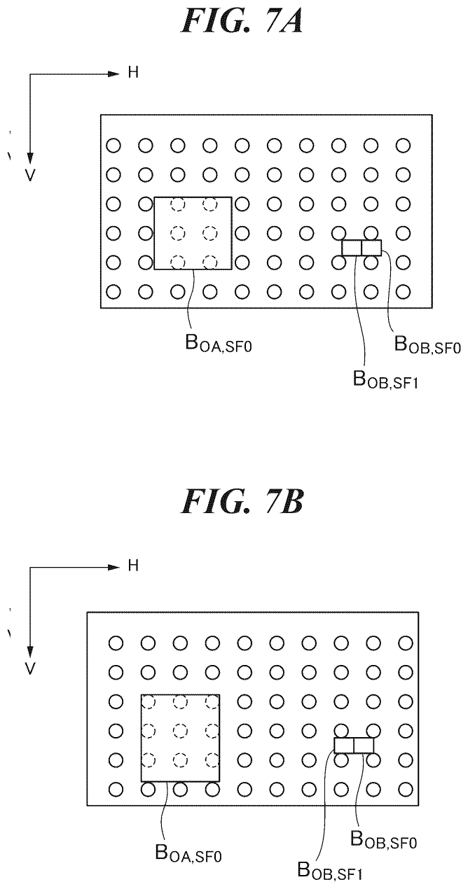

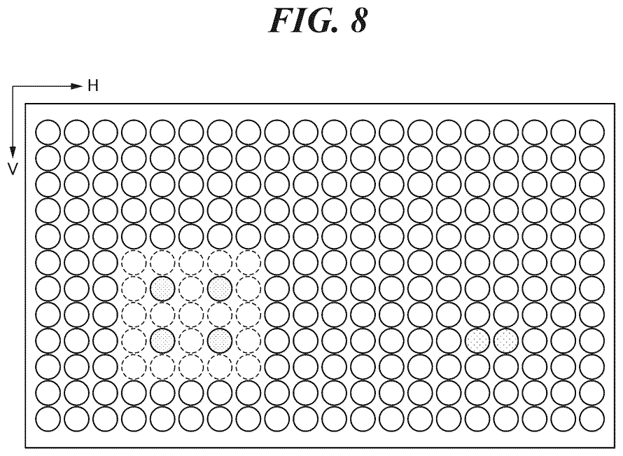

FIG. 6A is a diagram illustrating the measurement directions and reflection points in sub-frame 0. FIG. 6B is a diagram illustrating the measurement directions and reflection points in sub-frame 1. FIG. 7A is a diagram illustrating the measurement directions and reflection points in sub-frame 2. FIG. 7B is a diagram illustrating the measurement directions and reflection points in sub-frame 3. Further, FIG. 8 is a diagram illustrating the measurement directions and reflection points of a unit frame, which combines sub-frames 0 to 3. Here, in each diagram, for ease of explanation, the number of measurement directions has been reduced from that shown in FIG. 3.

As shown in FIG. 6A, multiple reflection points (shown with patterns in the figure) are detected when the measurement light is reflected from object O_{A} in response to the measurement light directed toward area GR_{OA,SF0}, and one reflection point (shown with patterns in the figure) is detected when the measurement light is reflected from object O_{B} in response to the measurement light directed toward area GR_{OB,SF0}. Correspondingly, as shown in FIG. 6B, areas B_{OA,SF0}, B_{OB,SF0} are set as areas where measurement is omitted from the next sub-frame onwards, i.e., areas where measurement directions are thinned out. In the figure, each area B_{OA,SF0}, B_{OB,SF0} is indicated by a rectangle. The detailed method for setting each area B_{OA,SF0}, B_{OB,SF0} will be described later. In each of the next and subsequent sub-frames which are sub-frames 1, 2, and 3, each measurement direction included in each of the established areas B_{OA,SF0}, B_{OB,SF0} is thinned out from each measurement direction group of sub-direction groups A1 to A3.

As shown in FIG. 6B, for example, from sub-direction group A1 of sub-frame 1, a total of six measurement directions are thinned out: three in the H direction and two in the V direction, corresponding to area B_{OA,SF0}. Here, in the example of FIG. 6B, since there is no measurement direction included in area B_{OB,SF0}, no measurement direction is thinned out corresponding to area B_{OB,SF0}. Further, in sub-frame 1, one reflection point which corresponds to object O_{B} is detected for the measurement light incident on area GR_{OB,SF1}.

As shown in FIG. 7A, from sub-direction group A2 of sub-frame 2, a total of six measurement directions are thinned out: two in the H direction and three in the V direction, corresponding to area B_{OA,SF0}. Further, if there are measurement directions corresponding to area GR_{OB,SF0} and area GR_{OB,SF1}, they are also thinned out. Here, note that FIG. 7A shows a case where there is no measurement direction to be thinned out corresponding to area GR_{OB,SF0} and area GR_{OB,SF1}.

Similarly, as shown in FIG. 7B, from sub-direction group A3 of sub-frame 3, a total of six measurement directions are thinned out: three in the H direction and two in the V direction, corresponding to areas B_{OA,SF0}. Further, if there are measurement directions corresponding to area GR_{OB,SF0} and area GR_{OB,SF1}, they are also thinned out. Here, note that FIG. 7B shows a case where there are no measurement directions to be thinned out corresponding to areas GR_{OB,SF0} and area GR_{OB,SF1}.

As shown in FIG. 8, when all sub-frames 0 through 3 are combined to one unit frame as a whole, a number of four measurement directions corresponding to object O_{A} and a number of two measurement directions corresponding to object O_{B} are obtained. Each measurement direction is indicated by a pattern in the figure. Further, of the five measurement directions in each of the H direction and V direction, which include the four measurement directions corresponding to object O_{A}, the measurement directions other than the four measurement directions corresponding to object O_{A} are thinned out. The thinned out measurement directions are each indicated by a dashed circle in the figure. In other words, when viewed as a whole unit frame, light is irradiated in each measurement direction represented by a solid circle in FIG. 8. The dashed circles are measurement directions that overlap with area B_{OA,SF0} and are not irradiated by the measurement light, while the solid circles are measurement directions that do not overlap with area B_{OA,SF0} and are irradiated by the measurement light.

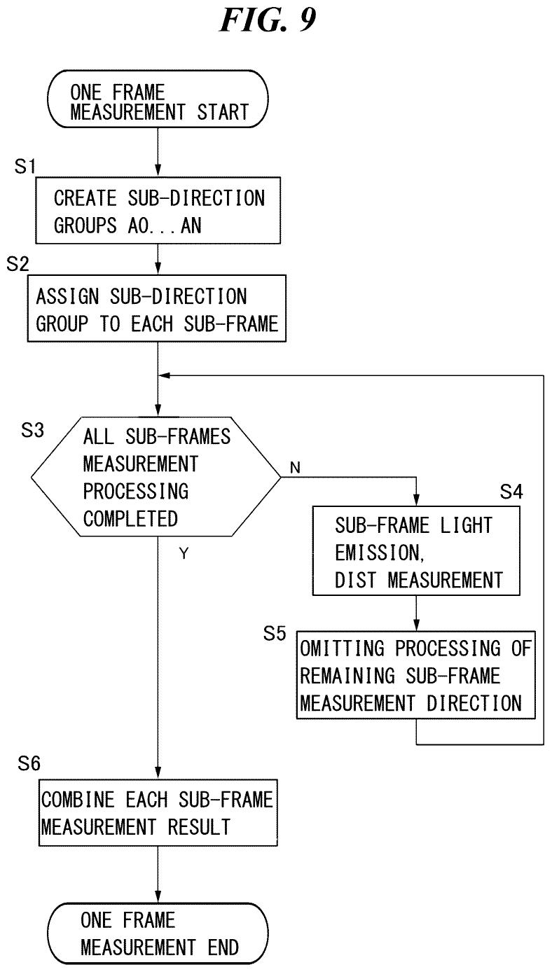

FIG. 9 is a flowchart showing the information processing flow for measuring one frame (one unit frame) of the distance measuring apparatus according to the present embodiment. Here, note that the flowchart shown here is merely an example, and the order of each process can be changed or other processes can be added as long as no contradictions or inconsistencies occur in the results of the information processing.

Measurement control unit 11 creates (N+1) sub-direction groups, each divided from the measurement direction group set according to the angular resolution (step S1). Specifically, for example, as shown in FIG. 3 described above, four sub-direction groups are created. Then, measurement control unit 11 assigns a sub-direction group to each sub-frame (step S2). Specifically, for example, as shown in FIG. 5 described above, a correspondence between each sub-frame and each sub-direction group is established.

Here, note that if the correspondence between each sub-direction group and each sub-frame is predetermined, the processing in steps S1 and S2 may be omitted. For example, by preparing data in advance that shows the correspondence between each sub-direction group and each sub-frame and storing the data in memory (not shown), measurement control unit 11 can read this data, thereby steps S1 and S2 can be omitted. Alternatively, information regarding each sub-direction group, etc. may be pre-installed in the operation program.

When measurement processing for all sub-frames is not completed (step S3; N), measurement control unit 11 controls deflection control unit 12 and illumination control unit 13 to emit measurement light to each measurement direction based on the corresponding sub-direction group, starting from sub-frame 0, and controls distance measurement unit 14 to measure distance based on the reflected light(s) (step S4). Further, measurement control unit 11 performs omitting processing (thinning processing) on the measurement direction(s) for the next and subsequent sub-frames based on each reflection point obtained by the measurement (step S5). Then, the process returns to step S3, and steps S4 and S5 are repeated until measurement processing for all sub-frames is completed (step S3; N).

When measurement processing for all sub-frames is completed (step S3; Y), measurement control unit 11 combines the measurement results of each sub-frame to obtain measurement result for one unit frame (step S6). This completes measurement of one unit frame. Thereafter, steps S1 through S6 are repeated for the required number of unit frames.

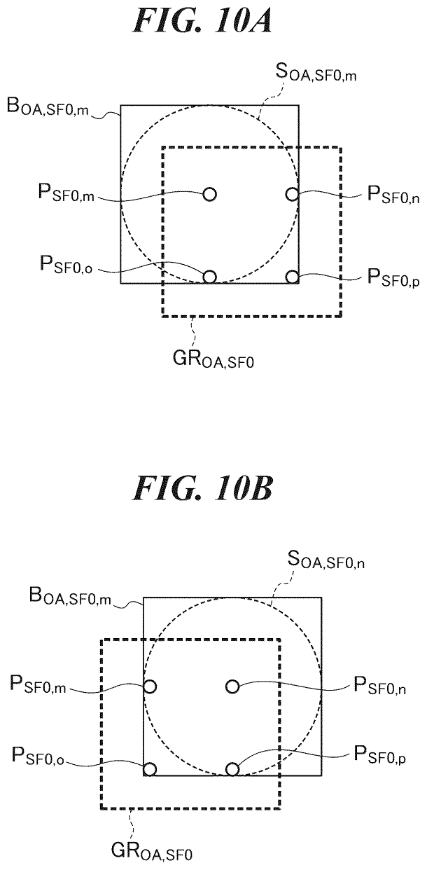

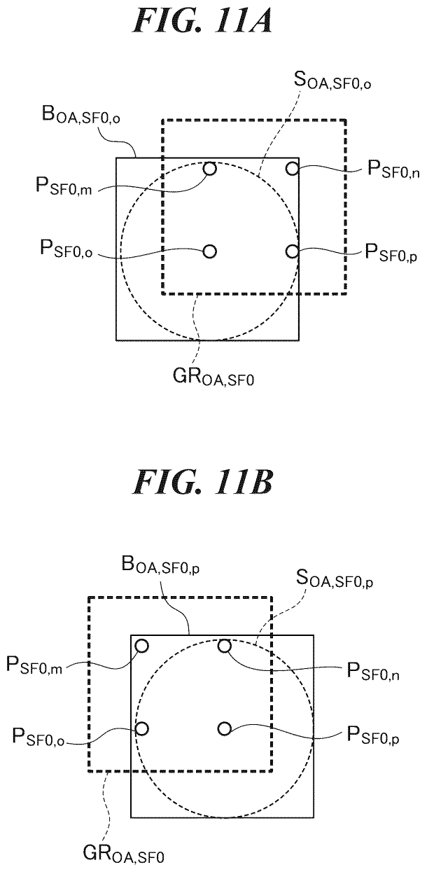

FIG. 10A, FIG. 10B, FIG. 11A, and FIG. 11B are diagrams each illustrating the method for setting area B, which is subject to thinning processing of the measurement direction(s) Here, the description also assumes the presence of object O_{A}, as shown in FIG. 4 described above. In each figure, the four reflection points stemming from object O_{A} are represented as P_{SF0,m}, P_{SF0,n}, P_{SF0,o}, and P_{SF0,p}. Area GR_{OA,SF0} includes these four reflection points.

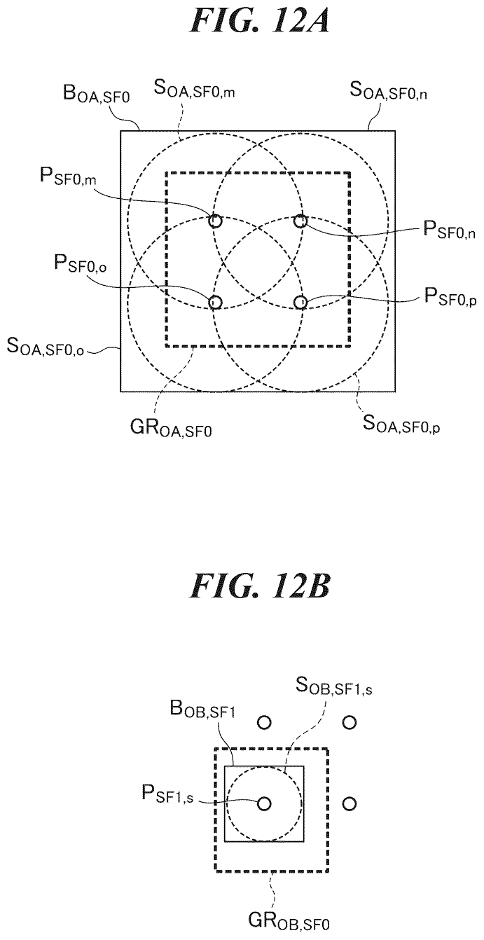

As shown in FIG. 10A, assuming a circle of radius d within a certain distance range centered on a reflection point P_{SF0,m}, and assuming that angle-converted value of the circle when the direction of the reflection point is 0° is S_{OA,SF0,m}, then the size of area B_{OA,SF0,m}, which is subject to be thinned out, is set to include angle-converted value S_{OA,SF0,m}. The circle radius d can be set to a value of approximately 5 to 15 mm, for example. This value is equivalent to the distance from the reflection point to the human pupil (the diameter of the pupil when open). That is, when the distance from light source unit 2 to reflection point P_{SF0,m} in area GR_{OA,SF0} is represented as D (P_{SF0,m}), then area B_{OA,SF0,m} is set to include circle S_{OA,SF0,m}, in order to omit measurement (light emission) in directions included in circle S_{OA,SF0,m}, which has a radius of arctan (d/D (P_{SF0,m})) [rad], which is the angle-converted value centered on reflection point P_{SF0,m}. Same applies to the other reflection points P_{SF0,n}, P_{SF0,o}, and P_{SF0,p}, and the sizes of areas B_{OA,SF0,n}, B_{OA,SF0,o}, and BO_{A,SF0,p} are set corresponding to angle-converted values S_{OA,SF0,n}, S_{OA,SF0,o}, and S_{OA,SF0,p}, respectively, as shown respectively in FIG. 10B, FIG. 11A, and FIG. 11B. As a result, as shown in FIG. 12A, in the vicinity of area GR_{OA,SF0}, each measurement direction within area B_{OA,SF0}, which is the union of areas B_{OA,SF0,m}, B_{OA,SF0,n}, B_{OA,SF0,o}, and BO_{A,SF0,p} is thinned out from each sub-direction group A0 to A3.

On the other hand, as shown in FIG. 12B, circle SO_{B,SF1,s} corresponding to reflection point P_{SF1,s}, which further corresponds to the relatively distant object O_{B}, is set in the same way. However, since the size of this circle S_{OB,SF1,s} is smaller than the angular resolution of the measurement direction group, area B_{OB,SF0} which is subject to thinning processing does not include any measurement direction other than the measurement direction corresponding to reflection point P_{SF1,s}.

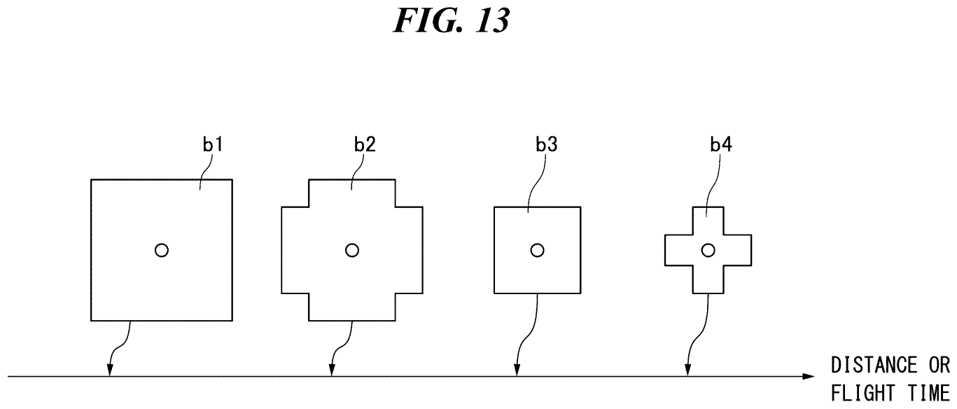

Here, in the above-described embodiment, it is assumed that area B which is subject to thinning processing is being set each time. However, it is also possible to set a pattern of area B which corresponds to the distance from the reflection point (or an equivalent converted value, such as light flight time measured at the reflection point) in advance and store the pattern in memory (not shown), and then use that area B pattern. That is, based on the distance determined at the reflection point, patterns b1, b2, b3, and b4 can be selected, as illustrated in FIG. 13.

In this illustrated example, the horizontal axis represents distance (or light flight time), with its value increasing to the right. Pattern b1 represents a pattern when the distance is relatively short, i.e., when the object is close, and is set to a relatively large rectangular shape. Pattern b2 represents a pattern when the distance is farther than pattern b1, and is set to a shape with the four corners of pattern b1 being removed. Pattern b3 represents a pattern when the distance is farther than pattern b2, and is set to a rectangular shape similar to pattern b1 and with a smaller area than patterns b1 and b2. Pattern b4 represents a pattern when the distance is farther than pattern b3, and, like pattern b2, is set to a shape with the four corners of pattern b2 being removed, and with a smaller area than patterns b1, b2, and b3. By arranging these patterns b1 to b4 centered on the reflection points according to their relative distance (or light flight time), area B subject to thinning processing can also be set. As illustrated, the shape of each pattern, that is, the area subject to thinning processing that includes a circle centered in the direction of the reflection point, does not necessarily have to be rectangular. It may be a shape consisting of a single rectangle, or a shape consisting of a collection of multiple rectangles. In other words, it is preferable that the area which includes area B but does not include angle converted value S to be minimized, thereby ensuring that the number of measurement directions subject to thinning process does not become unnecessarily great.

According to the above-described embodiment, in a distance measuring apparatus using laser light, a technology is realized that suppresses an increase in measurement time and ensure detection performance for a distant object.

According to the present embodiment, by thinning out the measurement direction of the measurement light in response to an object located at a relatively close range, it is possible to prevent excessive light from being irradiated onto the close-range object in a short period of time. As a result, even when the intensity of the light used for measurement is increased, safety for humans located within the measurement range is not compromised. Further, there is no need to extend time required to measure the unit frame.

Further, according to the present embodiment, since no thinning processing is performed on the measurement direction of an object located at a long distance, there is an advantage that detectability for the distant object is not impaired. Even when thinning processing is performed on a nearby object, a certain level of angular resolution is guaranteed, and since measurement light is irradiated at narrow intervals onto the nearby object, object detection performance is ensured. Since the above operation does not require an increase or a decrease in the output of measurement light from the light source unit, device configuration can be simplified, and therefore the apparatus can be made more compact.

Here, note that the present disclosure is not limited to the above-described embodiment, and various modifications can be made within the scope of the gist of the present disclosure. For example, while the number of sub-direction groups and sub-frames in the above-described embodiment was four, respectively, the numbers are not limited thereto and can be set as appropriate. Further, the arrangement of measurement directions included in each sub-direction group is not limited to the above-described embodiment as long as they are mutually exclusive.

### Modified Example 1

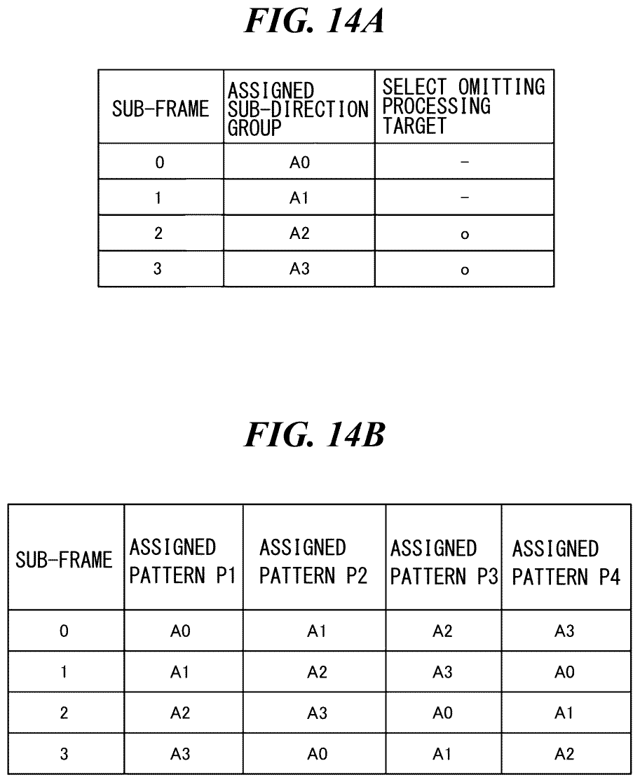

In the above-described embodiment, all sub-direction groups corresponding to all sub-frames except the first sub-frame were subject to thinning processing (omitting processing). However, the number of sub-direction groups subject to thinning processing may be reduced. As an example, similar to the embodiment described above, four sub-frames 0 to 3 and their corresponding four sub-direction groups A0 to A3 is assumed here. In this case, as shown in FIG. 14A, for example, two sub-direction groups A2 and A3 corresponding to two sub-frames 2 and 3 may be subject to thinning processing, while sub-direction group A1 corresponding to sub-frame 1 may be excluded from thinning processing. This is merely one example, and other combination is possible. For example, sub-direction groups A1 and A3 corresponding to sub-frames 1 and 3 may be subject to thinning processing.

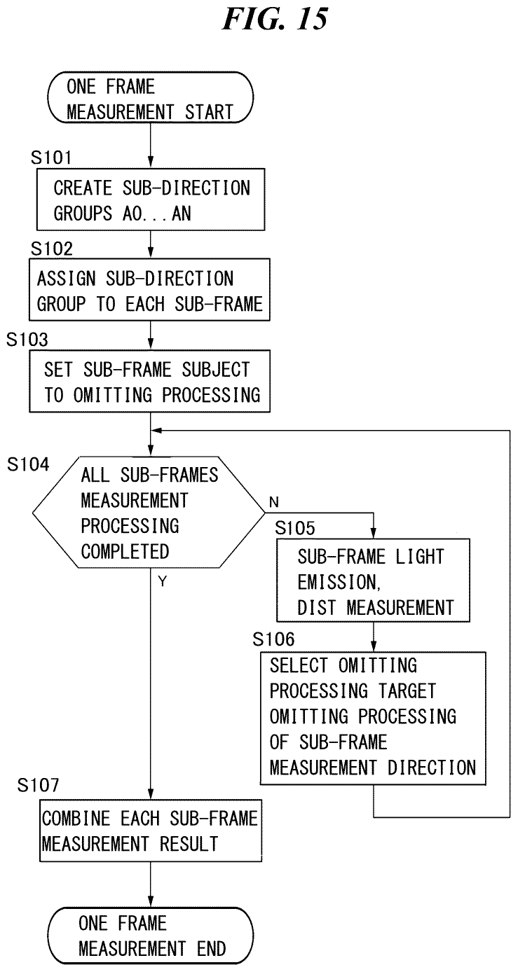

FIG. 15 is a flowchart showing the information processing flow for measuring one frame in the distance measuring apparatus of modified example 1. Here, note that the flowchart shown here is merely an example, and the order of each process can be changed or other processes can be added as long as no contradictions or inconsistencies occur in the results of the information processing.

Steps S101, S102, S104, S105, and S107 in the flowchart shown in FIG. 15 are the same as steps S1, S2, S3, S4, and S6 in the flowchart shown in FIG. 9 of the embodiment described above, and therefore, their descriptions will be omitted here. Step S103 is a step in which measurement control unit 11 sets the sub-frames and sub-direction groups to be subject to thinning processing (refer to FIG. 14A). Further, in step S106, only to the sub-frames set as targets for thinning processing, thinning processing is performed to the corresponding sub-direction groups. According to such modified Example 1, in addition to achieving the same effect as the above-described embodiment, it also achieves the effect of being able to adjust the degree of thinning out the measurement direction groups.

### Modified Example 2

In the process of assigning sub-direction groups for each sub-frame in step S2 of the flowchart shown in FIG. 9 in the above-described embodiment, or in step S102 of the flowchart shown in FIG. 15 in modified example 1, the sub-direction group assigned to each sub-frame may be swapped for each one frame. As one example, as in the above-described embodiment, four sub-frames 0 to 3 and four corresponding sub-direction groups A0 to A3 is assumed here.

In such a case, as illustrated in FIG. 14B, for each unit frame, the assigned pattern can be switched sequentially from P1 to P4. Specifically, in one unit frame, sub-direction groups A0, A1, A2, and A3 are assigned to sub-frames 0, 1, 2, and 3, respectively. In the next unit frame, sub-direction groups A1, A2, A3, and A0 are assigned to sub-frames 0, 1, 2, and 3, respectively. In the next unit frame, sub-direction groups A2, A3, A0, and A1 are assigned to sub-frames 0, 1, 2, and 3, respectively. And in the next unit frame, sub-direction groups A3, A0, A1, and A2 are assigned to sub-frames 0, 1, 2, and 3, respectively. By repeating this process in sequence, the measurement directions that are thinned out changes even when an object is present in a nearby area, thereby preventing a fixed measurement direction from being continuously thinned out and resulting in no measurement being performed. That is, when considering a unit frame combining sub-frames, it is possible to measure a nearby area in detail.

### Modified Example 3

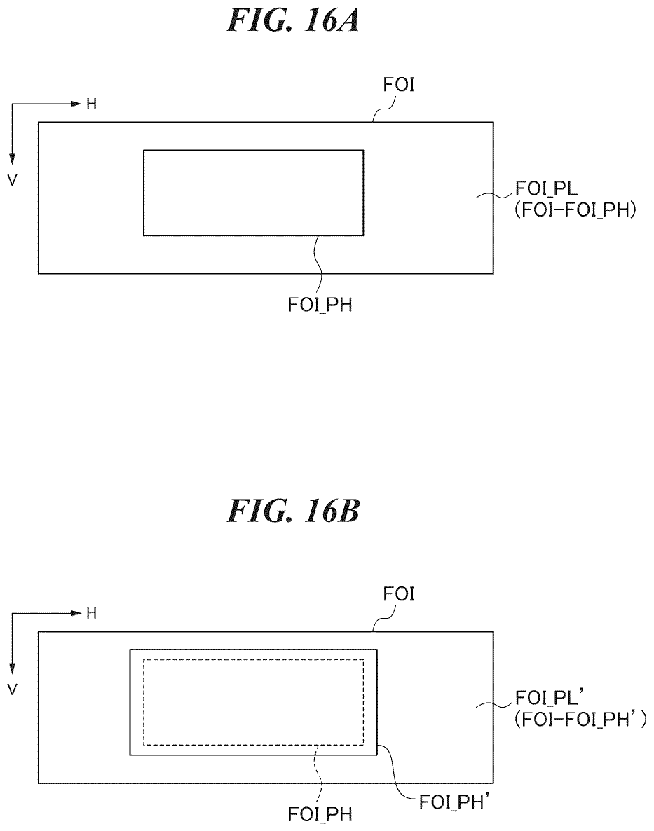

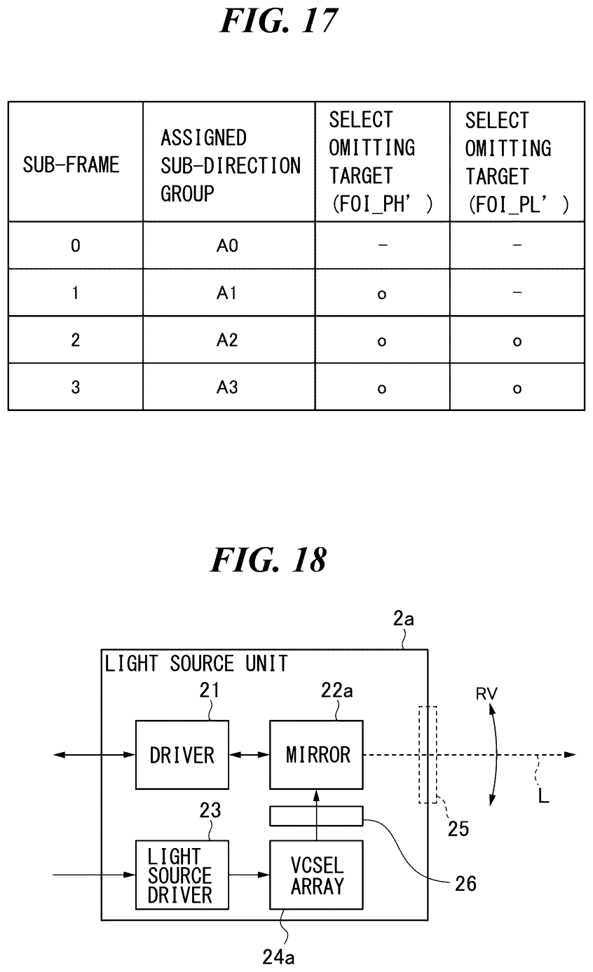

Thinning processing parameters may be configured to differ for each portion of the scanning target area FOI. For example, as shown in FIG. 16A, scanning target area FOI is divided into a central area FOI_PH and a peripheral area FOI_PL. In this example, scanning target area FOI not including central area FOI_PH becomes peripheral area FOI_PL. As illustrated in FIG. 16B, for reflection points in central area FOI_PH′, which is obtained by expanding central area FOI_PH by an angle equivalent to pupil radius, thinning processing can be performed in each corresponding sub-direction group for sub-frames 1 to 3, and for reflection points in peripheral area FOI_PL′ (of central area FOI_PH′), thinning processing can be performed in each corresponding sub-direction group for sub-frames 2 and 3 (refer to FIG. 17). In this modified example 3, pulsed light intensity can be changed for each portion of the scanning target area FOI. Specifically, the pulsed light intensity as the integral value per unit frame can be made relatively higher in peripheral area FOI_PL′ compared to that of central area FOI_PH′. Thus, this allows for more optimal measurement operation.

### Modified Example 4

The measurement directions that have been the subject of thinning process (or the directions of reflection points which serve as the basis for it) can be extracted by measurement control unit 11 and stored in memory, and processing can be performed to complement the thinned out measurement directions. For example, this can be substituted with distance information corresponding to the reflection points which serve as the basis. Thus, this can reduce differences in the result of post-processing, such as object recognition of point group information, between the distance measuring apparatus disclosed herein and a conventional distance measuring apparatus.

### Modified Example 5

In the above-described embodiments, a two-dimensional deflector capable of deflecting in two directions has been used as mirror 22 in light source unit 2. However, the light source unit can also be configured using a light source that emits laser light with an emission pattern shape that is elongated in one direction and a mirror that is deflectable in one direction. FIG. 18 illustrates a configuration example of a light source unit according to a modified example 5. The light source unit 2a illustrated in FIG. 18 is configured to include a driver 21, a mirror 22a, a light source driver 23, a VCSEL array 24a, and a lens array 26. VCSEL array 24a according to modified example 5 comprises a plurality of VCSEL (Vertical Cavity Surface-Emitting Lasers) light sources arranged in a straight line, and the overall emission pattern shape is approximately linear. By shaping the measurement light from VCSEL array 24a using lens array 26, the measurement light emitted from lens array 26 becomes light with an emission pattern shape that is elongated in one direction as a collection of multiple beams. VCSEL array 24a has a plurality of elements arranged in one direction, and each element can be turned on and off individually. Mirror 22a can be deflected in the direction of RV. Light incident on mirror 22a is reflected by mirror 22a and becomes light with an elongated emission pattern in a direction perpendicular to RV. Using light source unit 2a configured in this way can also achieve operation similar to that of the above-described embodiment.

### DESCRIPTION OF SYMBOLS

1: Control unit
2: Light source unit
3: Light receiving unit
11: Measurement control unit
12: Deflection control unit
13: Illumination control unit
14: Distance measurement unit
15: Communication unit
21: Driver
22: Mirror
23: Light source driver
24: Light source
31: Lens
32: Optical filter
33: Sensor
34: Light Receiving circuit

What is claimed is:

1. A distance measuring apparatus for measuring a distance to an object, comprising:
a light source that emits a laser light;
a deflector that generates a measurement light by deflecting the laser light;
a sensor that receives a reflected light which is generated when the measurement light is irradiated on the object;
a controller configured to control the operation of the light source and the deflector, and configured to measure the distance to the object based on the reflected light received by the sensor;
wherein a unit frame in which the controller measures the distance is divided into a plurality of sub-frames, and a measurement direction group assigned to each of the plurality of sub-frames is set to a mutually exclusive arrangement;
wherein, when a plurality of reflection points is detected in a first sub-frame, which is relatively earlier in time among the plurality of sub-frames, based on a light flight time at each of the plurality of reflection points or a converted value equivalent to the light flight time, the controller sets a first area that includes each of the plurality of reflection points; and
wherein, in a second sub-frame, which is at least one of the plurality of sub-frames which is relatively later in time than the first sub-frame, the controller controls the operation of the light source and the deflector so that the measurement light is not irradiated from the measurement direction group included in the second sub-frame to one or more measurement directions that overlap with the first area, and the measurement light is irradiated to the measurement direction that does not overlap with the first area.

2. The distance measuring apparatus according to claim 1,
wherein the density of the measurement directions assigned to each of the plurality of sub-frames is approximately equal.

3. The distance measuring apparatus according to claim 1,
wherein the arrangement of the measurement direction group assigned to each of the plurality of sub-frames is swapped every time the unit frame is repeatedly measured.

4. The distance measuring apparatus according to claim 1,
wherein the first area is set as an overlapping area of a fixed area approximately centered on each of the plurality of reflection points, and
wherein the size of the fixed area corresponding to each of the plurality of reflection points is determined based on the light flight time or the converted value corresponding to each of the plurality of reflection points.

5. The distance measuring apparatus according to claim 1,
wherein a scanning target area of the measurement light includes a first irradiation target area which is a part of the scanning target area, and a second irradiation target area which is a part other than the part of the scanning target area, and
wherein the number of the second sub-frame associated with the first irradiation target area and the number of second sub-frames associated with the second irradiation target area are set to different values.

6. The distance measuring apparatus according to claim 1,
wherein, among the plurality of sub-frames, all the sub-frames other than the first sub-frame are designated as the second sub-frame.

7. The distance measuring apparatus according to claim 1,
wherein the light source has a configuration in which a plurality of elements capable of individually controlling the emission of the laser light are arranged in one direction, and
wherein the deflector is a one-dimensional deflector.
